(19) United States
(12) Patent Application Publication
(10) Pub. No.: US 2014/0280401 A1
(43) Pub. Date: Sep. 18, 2014

(54) DATA FORMAT CONVERSION SYSTEM, INFORMATION ADMINISTRATION SYSTEM, INFORMATION SYSTEM, DATA FORMAT CONVERSION METHOD, CONTROL METHOD OF INFORMATION SYSTEM, PROGRAM OF THESE METHODS, AND RECORDING MEDIUM STORING THE PROGRAM

(71) Applicant: Masaki ARAI, Tokyo (JP)

(72) Inventor: Masaki ARAI, Tokyo (JP)

(73) Assignee: RICOH COMPANY, LTD., Tokyo (JP)

(21) Appl. No.: 14/205,929

(22) Filed: Mar. 12, 2014

(30) Foreign Application Priority Data
Mar. 15, 2013 (JP) 2013-053965
Mar. 3, 2014 (JP) 2014-040237

(51) Int. Cl. G06F 17/30

(52) U.S. Cl. CPC G06F 17/30076
USPC 707/827

(57) ABSTRACT

A data format conversion system of converting a format of electronic data includes a storing part that stores the electronic data and data information including format information indicative of a data format of the electronic data; a changing part that changes the data information stored in the storing part; a determining part that determines whether the format information included in the data information is changed by the changing part, an identifying part that identifies the data format using the format information when it is determined by the determining part that the format information is changed, and a converting part that converts the data format of the electronic data stored in the storing part based on the data format identified by the identifying part.

### BACKGROUND OF THE INVENTION

1. Field of the Invention

The present invention generally relates to a data format conversion system, an information administration system, an information system, a data format conversion method, and a control method of information system.

2. Description of the Related Art

There is known an example of a system (e.g., cloud computing) of outputting data (i.e., file data or the like) that are stored in an apparatus (i.e., a server or the like) to another apparatus (i.e., an information terminal or the like) using a network environment.

Patent Document 1 discloses a technique related to a file opening system where a file designated by a user is processed by a method corresponding to a file type of the designated file and the contents of the file.

Within the technique disclosed in Patent Document 1, there is a case where a file cannot be displayed when a file in a file server is displayed by an information terminal and the information terminal is not provided with a control program (a driver) corresponding to the file format (the data format) of the file (electronic data) to be displayed. Further, Patent Document 1 does not disclose a method of converting the file stored in advance in the server or the like to the file format of a control program that is provided with the information terminal.
Patent Document 1: Japanese Laid-Open Patent Application No. 2011-96079

### SUMMARY OF THE INVENTION

Accordingly, embodiments of the present invention provide a novel and useful data format conversion system and a data format conversion method solving one or more of the problems discussed above.

More specifically, the embodiments of the present invention may provide a data format conversion system and a data format conversion method where a data format of electronic data can be converted based on data information of electronic data that are stored in a predetermined folder in advance when the data information is changed.

One aspect of the embodiments of the present invention may be to provide a data format conversion system of converting a format of electronic data including a storing part that stores the electronic data and data information including format information indicative of a data format of the electronic data; a changing part that changes the data information stored in the storing part; a determining part that determines whether the format information included in the data information is changed by the changing part, an identifying part that identifies the data format using the format information when it is determined by the determining part that the format information is changed, and a converting part that converts the data format of the electronic data stored in the storing part based on the data format identified by the identifying part.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 is a schematic structure diagram illustrating an example of a data format conversion system of a first embodiment of the present invention;

FIG. 2 illustrates an exemplary hardware configuration of a computer system of the first embodiment of the present invention;

FIG. 3 is a functional block diagram illustrating an example of the function of a data format conversion system of the first embodiment of the present invention;

FIG. 4 is a flowchart illustrating an example of the operation of the data format conversion system of the first embodiment of the present invention;

FIG. 5 is a schematic structure diagram illustrating an exemplary information administration system of a second embodiment of the present invention;

FIG. 6 is a functional block diagram illustrating an example of the function of an information administration system of the second embodiment of the present invention;

FIG. 7 is a flowchart illustrating an example of the operation of the information administration system of the second embodiment of the present invention;

FIG. 8 is a schematic structure diagram illustrating an exemplary information administration system of a third embodiment of the present invention;

FIG. 9 is a functional block diagram illustrating an example of the function of an information administration system of the third embodiment of the present invention;

FIG. 10 is a flowchart illustrating an example of the operation of the information administration system of the third embodiment of the present invention;

FIG. 11 is a functional block diagram illustrating an example of the function of a file format conversion system (a file server system) of Example 1 of the present invention.

FIG. 12 is a flowchart illustrating an example of the operation of the file format conversion system (the file server system) of Example 1 of the present invention;

FIG. 13 illustrates an example of a so-called format conversion table used in the file format conversion system (the file server system) of Example 1 of the present invention;

FIG. 14 is a schematic structure diagram illustrating an exemplary information system of Example 2 of the present invention;

FIG. 15 is a schematic system chart illustrating an exemplary information system of Example 2 of the present invention;

FIG. 16 illustrates an exemplary hardware configuration of an information terminal 210SP of Example 2 of the present invention;

FIG. 17 illustrates an exemplary hardware configuration of an external apparatus (MFP) 220E of Example 2 of the present invention;

FIG. 18 is a functional block diagram illustrating an example of the function of an information system of Example 2 of the present invention; and

FIG. 19 is a flowchart illustrating an exemplary information system of Example 2 of the present invention.

### DETAILED DESCRIPTION OF THE PREFERRED EMBODIMENTS

A description is given below, with reference to the FIG. 1 through FIG. 19 of embodiments of the present invention. Where the same reference symbols are attached to the same parts, repeated description of the parts is omitted. The embodiments of the present invention are applicable to an information administration system, information accumulating system, an information processing system, a file server, so-called cloud computing, other information systems, and any thing including an apparatus, a machine, a unit, a system or the like by which a data format stored in the other is converted, in addition to the data format conversion system described below.

In the following explanation, the same or corresponding reference symbols are attached to the same or corresponding apparatuses, devices, parts, members or the like, and overlapping explanation is omitted. Further, the figures are not illustrated to limit a relationship among the apparatuses, the devices, the parts, or the members as long as it is not specifically designated to limit the relationship. Therefore, a specific relationship can be determined by a person ordinarily skilled in art in light of the non-limiting embodiments described below.

Reference symbols typically designate as follows:
10: data format conversion system;
11A: changing part;
11B: determining part;
12: identifying part;
13: converting part;
Cntr: controlling part;
Memr: storing part;
InIF: inputting part;
OutIF: outputting portion;
100, 100A, 100B: information administration system;
110: information administration apparatus;
112: information administration program;
113: external converting apparatus;
120: information accumulating apparatus;
121: reporting part;
130: information processing apparatus;
200: information system;
210: information terminal (tablet terminal, personal computer)
211: editing portion;
212: outputting portion;
220: communication device;
220E: external apparatus (MFP);
Pr: program; and
Md: recording medium.

### First Embodiment

The first embodiment of the present invention is described in an order described below using the data format conversion system 10 of the first embodiment.

1. Summary
1.1 Summary of system
1.2 Combining modules

2. Configuration (Hardware Configuration)

3. Function

4. Processing flow

### (1. Summary)

### (1.1 Summary of System)

Referring to FIG. 1, the summary of the data format conversion system 10 of the first embodiment is described. The data format conversion system 10 is provided to convert the data format of electronic data that are stored in a predetermined folder in advance.

The data format conversion system 10 includes a changing part 11A that changes data information (i.e., property information or the like) including format information indicative of the data format of electronic data, a determining part 11B that determines whether the format information included in the data information is changed, an identifying part that identifies the data format based on the determined result, and a converting part 13 that converts the data format based on the identified data format. Further, the data format conversion system 10 is provided with a controlling part Cntr that controls an entire operation of the data format conversion system 10 of the first embodiment.

Further, the data format conversion system 10 may include a storing part Memr that stores operation conditions, operation states, processing result, or information (hereinafter “system information”) related to a system. Further, the data format conversion system 10 may further includes an inputting part InIF where the system information (e.g., an electric signal) is input from the outside of the data format conversion system 10 and an outputting portion OutIF outputting the system information to the outside of the data format conversion system 10. Further, the data format conversion system 10 may have a configuration using a storing part Memr located outside the data format conversion system, an inputting part InIF, and an outputting part OutIF.

The data format conversion system 10 of the first embodiment substantializes a change function for changing data information including data information indicative of data format of the electronic data using the changing part 11A to be changed. Further, the data format conversion system 10 substantializes a determination function of determining whether the format information contained in the data information is changed by the changing part 11A using the determining part 11B. The data format conversion system 10 substantializes an identification function of identifying the data format using the identifying part 12 based on the data information of the electronic data. Further, the data format conversion system 10 substantializes a convert function of converting the data format of the electronic data based on the data format identified by the identifying part 12 using the converting part 13.

Here, the electronic data is file data such as text data, document data, image data, movie data, audio data, and an execution file.

Further, the data information is property information related to attribute and a setup of data that contains information related to the data format. The data information may include, for example, “information related to the conversion which had been performed”. The data information may include “information (character string) related to the extension” and “information (character string) related to the file name”, which correspond to the file format when the data format is the file format.

### (1.2 Combining Modules)

The change function, the determination function, the identification function, and the convert function, respectively, of changing part 11A, the determining part 11B, the identifying part 12, and the converting part 13 are variously combined to substantialize a plurality of other functions. As an example of the plurality of other functions, a data format convert function is explained. The plurality of other functions are substantialized when the controlling part Cntr of the data format conversion system 10 executes a program and collaborates with the hardware.

The data format conversion system 10 of the first embodiment substantializes the data format convert function that can be used for an arbitrary information system in common by an input and an output of the data. Said differently, the data format convert function provided by the data format conversion system 10 performs these functions (the change function, the determination function, the identification function, and the convert function), respectively. The storing part Memr, the inputting part InIF, and the outputting part OutIF are appropriately used to convert the data format.

In consideration of these points, the data format conversion system 10 may have a configuration where these functions are connected using a typical interface. The typical interface can use a communication protocol (e.g., a file transfer protocol) such as Sever Message Block (SMB) and Common Internet File System (CIFS). Further, in the data format conversion system 10, a module, a driver, or the like may be appropriately added so that the data format convert function corresponds to other data formats (a file format, a format, a version up, or the like. Meanwhile, the service (e.g., TCP/IP, SMB, CIFS, and other file sharing service) substantializing the file transfer is provided in a form where this service is included in an OS in many cases. An information processing apparatus ordinarily has this service.

As described above, the data format conversion system 10 of the first embodiment can provide a function of using an arbitrary information system (the data format convert function) in common. Further, according to the data format conversion system 10 of the first embodiment, it is possible to flexibly deal with a new data format by adding the module or the like. Further, according to the data format conversion system 10 of the first embodiment, it is possible to flexibly deal with a plurality of data formats by causing the data format conversion system 10 to be connected with a device or the like for a new application.

### (2. Configuration)

Referring to FIG. 1, the configuration of the data format conversion system 10 of the first embodiment is described.

Referring to FIG. 1, the data format conversion system 10 of the first embodiment includes the changing part 11A, the determining part 11B, the identifying part 12, and the converting part 13. Further, as described above, the data format conversion system 10 includes the controlling part Cntr, the storing part Memr, the inputting part InIF, and the outputting part OutIF.

The changing part 11A changes the data information. The changing part 11A changes, in response to an input operation by a user or the like, the data information of the electronic data that are stored in advance inside a predetermined folder of the storing part Memr (described below).

The determining part 11B determines whether the data information of the electronic data is changed. The determining part 11B determines whether the data information is changed by periodically detecting (performing polling) the data information of the electronic data stored in advance inside a predetermined folder of the storing part Memr and comparing the result of this detection with the result of the detection at the previous time. Specifically, the determining part 11B can determine whether the property information (the data information) is changed by comparing property information in the previous detection with property information in the current detection.

The determining part 11B may determine whether the data format of the electronic data is changed based on only data information that is occasionally detected and using the information or the like that is stored in advance in the storing part Memr (described below). Further, the determining part 11B may use a method of receiving a callback at a time oc changing the data information.

The identifying part 12 identifies the data format of the electronic data whose information is processed. The identifying part 12 identifies the data format based on the data information (e.g., the format information indicative of the data format) that is detected by the determining part 11B in a case where the data information of the electronic data is determined to be changed. The identifying part may select (identify) the data format using information (a table, a list, or other data) stored in, for example, a storing part Memr.

The data format of the first embodiment is information related to a type, a form, a structure, a format, or the like of data subjected to information processing. The data format is, for example, a file format of, for example, the file data.

The converting part 13 converts the data format of the electronic data. The converting part 13 of the first embodiment converts the data format of the electronic data stored inside a predetermined folder of the storing part Memr based on the data format identified by the identifying part 12. The converting part 13 may convert the data format of the electronic data by further using the information (a mathematical formula, a program, a table, or other data) stored in advance in, for example, the storing part Memr.

Further, the converting part 13 may add the “information related to the conversion which had been performed” to the data information of the converted electronic data. With this, the data format conversion system 10 can effectively search (detect) the converted electronic data stored in the storing part Memr by detecting the added “information related to the conversion which had been performed” in conformity with an operation instruction received from the outside.

Further, the converting part 13 may store a copy of the electronic data inside a predetermined folder before converting the electronic data. With this, the data format conversion system 10 can select another conversion performed again using original data (data before the conversion) or no conversion in a case where the conversion is stopped by an unpredictable reason during the conversion of the data format of the electronic data. Further, the data format conversion system 10 can convert the original data (the data before the conversion) in a case where the converted data includes a defect.

The controlling part Cntr controls an operation in each configuration forming the data format conversion system 10. The controlling part Cntr of the first embodiment controls the operation or the like of converting the data format of the electronic data by controlling the operation of the data format conversion system 10.

Specifically, the controlling part Cntr controls the operation of the changing part 11A so that the changing part 11A changes the data information. Further, the controlling part Cntr controls the operation of the determining part 11B so that the operation of determining whether the format information included in the data information is changed is controlled. The controlling part Cntr controls the operation of the identifying part 12 so that the operation by the identifying part 12 of identifying the data format is controlled. Further, the controlling part Cntr controls the operation of the converting part 13 so that an operation by the converting part of converting the data format is controlled. The controlling part Cntr may be formed by an include a known arithmetic processing unit including a central processing unit (CPU), a memory (ROM, RAM, or the like), a control unit, and so on.

The storing part Memr stores system information or the like related to the data format conversion system 10. The storing part Memr of the first embodiment has a memory area (hereinafter, a “predetermined folder”) where the electronic data are stored. With this, the data format conversion system 10 can store the electronic data whose data format are not yet converted and the electronic data after converting the data format using the storing part Memr. Further, the storing part Memr can store the result of the determination obtained by determining by the determining part 11B, the result of the identification obtained by identifying by the identifying part 11B, and the result of the conversion obtained by converting by the converting part 13. The storing part Memr may be a known hard disk, a memory, a ROM, a RAM, a DVD, a tape drive, or the like.

The inputting part InIF is provided to input the information from the outside of the format conversion system 10. The inputting part InIF receives the system information or the like of the data format conversion system 10 from an external apparatus (e.g., an information terminal) using a wired communication and/or a wireless communication. The inputting part InIF may include an input portion (e.g., a user interface such as an operation panel) with which the system information is input by the user into the data format conversion system 10.

The outputting part OutIF is provided to output the information to the outside of the format conversion system 10. The outputting part OutIF outputs the system information or the like of the data format conversion system 10 to the external apparatus (e.g., the information terminal) using the wired communication and/or the wireless communication. The outputting part OutIF may include an output portion (e.g., a display portion such as a touch panel) that outputs (displays) the information to the outside of the data format conversion system 10.

### [Hardware Configuration]

The above data format conversion system 10 is substantialized by a computer system 1000 having a hardware structure illustrated in, for example, FIG. 2. FIG. 2 illustrates an exemplary hardware configuration of the computer system of the first embodiment of the present invention.

The computer system 1000 includes an input device 101, a display device 102, an external I/F 103. a RAM 104, a ROM 105, a CPU 106, a communication I/F 107, and an HDD 108, and so on, which are mutually connected by a bus B. The input device 101 may include a keyboard, a mouse, and so on, which are used to input various operation signals to the computer system 1000.

The display device 102 includes a display or the like, which displays a processing result obtained by the computer system 1000. The communication I/F 107 is an interface for connecting the computer system 1000 with a network. Thus, the computer system 1000 can perform data communications with another device and/or another apparatus through the communication I/F 107.

The HDD 108 is a non-volatile memory device that stores programs and data. The stored program and data are the operating system (OS), which is basic software controlling the entire computer system 1000, application software providing various functions in the OS, and so on. The HDD 108 administrates the stored program and data with a predetermined file system and/or a data base (DB).

The external I/F 103 is an interface with the external apparatus. The external apparatus is a recording medium 103a or the like. With this, the computer system 1000 can read information from the recording medium 103a and/or write information to the recording medium 103a through the external I/F 103. The recording medium 103a includes a flexible disk, a CD, a Digital Versatile Disk (DVD), an SD memory card, a Universal Serial Bus (USB) memory, or the like.

The ROM 105 is a non-volatile semiconductor memory (memory device) which can hold program and/or data even when a power source is powered off. The ROM 105 stores a program and data for a Basic Input/Output System (BIOS), OS setup, network setup, or the like, which are executed at a time of booting up the computer system 1000. The RAM 104 is a volatile semiconductor memory (memory device) temporarily storing a program and/or data.

The CPU 106 reads the program and/or data from the memory device such as the ROM 105, the HDD 108, or the like. The read program or the read data undergo a process to thereby substantialize a control or a function of the entire computer system 1000.

The computer system 1000 of the first embodiment can realize various processes described below by the above hardware configuration.

### (3. Function)

Referring to FIG. 3, an exemplary function of the data format conversion system 10 of the first embodiment is described.

As illustrated in FIG. 3, the data format conversion system 10 (see FIG. 1) outputs information (hereinafter, referred to as an “operation instruction”) that is related to the operation of the data format conversion system 10 obtained (input) by using the inputting part InIF to the controlling part Cutr (see B201 of FIG. 3). The “operation instruction” may be output in response to information related to an operation instruction (an execution request, a processing request, a thread, a process, a task or the like) of a personal computer (PC) in a case where the data format conversion system 10 of the first embodiment is installed in the PC.

The controlling part Cntr controls the operation of the data format conversion system 10 based on the input “operation instruction” (see B202). Specifically, the controlling part Cntr outputs a “change instruction” to the changing part 11A in a case where the “operation instruction” is the “instruction related to the change of the data format”. Further, the controlling part Cntr outputs a “determination instruction” to the determining part 11B in a case where the “operation instruction” is the “instruction related to the change of the data format”. Further, the controlling part Cntr outputs the “identification instruction” and the “conversion instruction” to the identifying part 12 and the converting part 13 in a case where the “operation instruction” is the “instruction related to the conversion of the data format”. Further, the controlling part Cntr or the inputting part InIF (B201) may further output the “operation instruction” or the like to the storing part Memr.

The changing part 11A changes the data information based on the input “change instruction” (see B203A). At this time, the determining part 11B determines whether the format information is changed by the changing part 11A (see B203B). Further, the determining part 11B outputs a result (hereinafter, “determination data”) of the determination to the identifying part 12 (and the storing part Memr 60) (see B203B). Specifically, the determining part 11B of the first embodiment periodically detects the data information of the electronic data that are stored in advance in a predetermined folder of the storing part Memr as a determination step. With this, the determining part 11B can determine whether the data information is changed.

The identifying part 12 identifies the data format based on the input “determination data” (see B204). Further, the identifying part 12 outputs a result (hereinafter, referred to as “identification data”) of the identification to the converting part (and the storing part Memr) (see B204). Specifically, the identifying part 12 identifies the data format based on the format information included in the data information that are determined by the determining part 11B.

The converting part 13 converts the data format of the electronic data based on the input “identification data” (and the “determination data”) (see B205). Further, the converting part 13 outputs a result (hereinafter, referred to as “conversion data”) of the conversion to the storing part Memr (see B205). Specifically, the converting part 13 converts the electronic data stored in a predetermined folder of the storing part Memr to a data format identified by the identifying part 12 (see B204) as a conversion step. The converting part 13 may further perform an addition of the “information related to the conversion which had been performed” to the data information of the converted electronic data (an information addition step) and a storage of a copy of the electronic data in a predetermined folder (the storing part 14) before converting the electronic data (a copy storage step).

The storing part Memr stores the “determination data” of the determining part 11B, the “identification data” of the identifying part 12, and the “conversion data” of the converting part 13. The storing part Memr can store information related to, for example, data after converting the format of the data.

The outputting part OutIF outputs information (system information or the like) stored in the storing part Memr (see B207). Further, the outputting part OutIF can output the converted electronic data, for example.

### (4. Processing Flow)

Referring to FIG. 4, an exemplary operation of converting the data format of the electronic data by the data format conversion system 10 of the first embodiment is described.

At first, as illustrated in FIG. 4, the data format conversion system 10 starts a determination operation in step S301. Here, the determination operation of the first embodiment is an operation (e.g., a monitoring operation) of repeating the determination operation at a predetermined time interval in order to determine in real time the change of the format information included in the data information of the electronic data. After starting the change determination operation, the data format conversion system 10 performs step S302.

Next, in step S302, the data format conversion system 10 detects a change of the format information included in the data information of the electronic data using the determining part 11B (the determination step). Specifically, the determining part 11B of the first embodiment periodically detects the data information of the electronic data that are stored in advance in a predetermined folder of the storing part Memr. Subsequently, the determining part 11B compares the data information (the format information) at the previous detection with the data information (the format information) of the current detection so as to determine whether the data information (the format information) is changed. Thereafter, the determining part 11B outputs determination data obtained by determining whether the data information (the format information) is changed to the identifying part 12. After outputting the determination information, the data format conversion system 10 goes to step s303.

Subsequently, in step S303, the data conversion system 10 identifies the data format of the electronic data to be changed based on the changed data information using the identifying part 12 (the identifying step). Thereafter, the identifying part 12 outputs the identification data to the converting part 13. After outputting the identification data, the data format conversion system 10 goes to step s304.

In step S304, the data format conversion system 10 generates a copy of the electronic data to be converted using the converting part 13. Further, the data format conversion system 10 stores the generated copy using the storing part Memr (a copy storage step). The order of performing steps S303 and S304 is not specifically limited. After storing the generated copy, the data format conversion system 10 goes to step s305.

In step S305, the data format conversion system 10 converts the data format of the electronic data based on the identification data obtained by identifying the data format of the electronic data in step S303 using the converting part 13. Thereafter, the converting part 13 outputs the conversion data obtained by converting the data format to the storing part Memr. After outputting the conversion data, the data format conversion system 10 goes to step S306.

In step S306, the data format conversion system 10 stores the electronic data whose data format is converted using the storing part Memr. After storing the electronic data whose data format is converted, the data format conversion system 10 goes to step s307.

In step S307, the data format conversion system 10 uses the controlling part Cntr or the like to update the data information of the converted electronic data (an information addition step). Specifically, the controlling part Cntr or the like can add the “information related to the conversion which had been performed (or a character string)” to the data information (the property information or the like) of the converted electronic data. Thereafter, the data format conversion system 10 proceeds to END in FIG. 4 where the operation of converting the data format ends.

As an example, the above process is described in a case where the folder stores electronic data named “xxx.doc” and a user converts the electronic data to “xxx.jpg”.

The data format conversion system 10 causes a list of the electronic data in a folder where the electronic data named “xxx.doc” are stored to the outputting part OutIF. When the inputting part InIF receives an input of the user's instruction of changing the extension (format information included in the data information of the electronic data) of the name “xxx.doc” (the data information of the above electronic data) of the electronic data, the data format conversion system changes the name and the format of the electronic data to “jpg”.

When the data format conversion system 10 detects the change of the above extension in step S302, the data format conversion system 10 identifies that the data format of the changed extension is a “jpg” format file in step S303. Thereafter, the electronic data of “xxx.doc” before the conversion is copied in step S304.

After the copy, the data format of the electronic data whose name is changed to “xxx.jpg” is changed to a “doc” format in step S305. Then the file “xxx.jpg” whose data format is converted is stored in the storing part in step S306.

As described, the data format conversion system 10 converts the data format of the electronic data base on the changed data information in a case where the data information that includes the format information indicative of the data format of the electronic data that are stored in advance in the predetermined folder. Further, the data format conversion system 10 of the first embodiment determines whether the data information (the format information) is changed using the determining part 11B, and the data format is identified using the identifying part 12. Therefore, the electronic data are converted to the data format identified using the converting part 13. Further, because the data format conversion system 10 converts the electronic data to have the identified data format, the electronic data are converted to the data format (the file format) desired by the user at a timing desired by the user without previously setting the data format to which the electronic data are converted.

Further, in a case where the data format conversion system 10 of the first embodiment is used in a system where the data format (the file format) is converted by moving the electronic data (or the file) to a folder, the data format conversion system 10 converts the data format of the electronic data without moving the electronic data (file) to another folder. With this, it is possible to convert the format of the electronic data (a file) in response to an operation from a device where the folder storing a file of the source of conversion and a file of the destination of conversion are not simultaneously displayed because a move operation is unnecessary according to the data format conversion system 10. Further, in a case where the data format conversion system 10 of the first embodiment is set up so that the data format of the electronic data are automatically converted and stores in a folder storing the electronic data (the file), the electronic data can be converted to have a desired format without converting the setup of the folder.

Further, as exemplified above, the configuration of converting the data format of the electronic data is substantialized by changing the extension contained in the name of the electronic data, and the electronic data can be used in software corresponding to the extension. For example, it is impossible to display the electronic data having the “doc” format whose extension of name is merely changed to “jpg” using image preview software corresponding to the “jpg” extension. However, with the above configuration, the electronic data of the “doc” format are converted to the electronic data of the “jpeg” format, and it becomes possible to appropriately browse the electronic data whose extension of name is changed to “jpg” using the image preview software.

### Second Embodiment

An information administration system 100A of a second embodiment of the present invention is described. The configuration or the like of the information administration system 100A includes the configuration or the like of the data format conversion system 10 of the first embodiment. Therefore, a portion different from the information administration system 100A is mainly described.

1. Configuration

2. Function

3. Processing flow

### (1. Configuration)

Referring to FIG. 5, the configuration of the information administration system 100A (100) of the first embodiment is described. Here, the information administration system 100A is provided to administer (convert a data format, for example) the electronic data stored in advance in the predetermined folder.

The information administration system 100A includes an information administration apparatus 110 provided with a converting part 13 and an information administration program 112 for controlling an operation of the converting part 13 or the like. Further, the information administration system 100A further includes an external converting apparatus 113 that converts the data format of the electronic data. Meanwhile, the configuration of the information administration system 100A is an example and can be used for various system or configuration examples in response to a usage or a purpose.

The information administration system 100A determines whether the converting part 13 can convert the data format of the electronic data using the controlling part Cntr. When it is determined that the converting part 13 can convert the data format of the electronic data, the data format of the electronic data is converted using the converting part 13. Subsequently, the information administration system 100A (the information administration apparatus 110) stores the converted data in the storing part Memr. On the other hand, in a case where the information administration apparatus 110 determines that the data format of the electronic data is not converted, the information administration apparatus 110 outputs the electronic data to the external converting apparatus 113. Subsequently, the information administration system 100A (the information administration apparatus 110) stores the electronic data input from the external converting apparatus 113 in the storing part Memr.

The information administration program 112 is provided to control operations of the changing part 11A, the determining part 11B, the identifying part 12, the converting part 13, and the other parts of the information administration system 100A. The information administration program 112 includes a program for controlling an operation of outputting a result of the identification identified by, for example, the identifying part 12 to the information administration apparatus 110. The information administration system 100A of the second embodiment stores the information administration program 112 in the controlling part Cntr (a storage unit). The information administration program 112 may be stored in the storing part Memr.

Here, the controlling part Cntr controls the operation of the information administration apparatus 110 using the information administration program 112. The controlling part Cntr controls the operation of identifying the data format using, for example, the identifying part 12 based on the result of the determination obtained by the determining part 11B. Further, the controlling part Cntr controls an operation of outputting a result of the identification obtained by, for example, the identification part 12 to the information administration apparatus 110.

The external converting apparatus 113 converts the data format of the electronic data. The external converting apparatus 113 converts the data format of the electronic data based on the result of the identification obtained by the identifying part 12 and the result of the determination obtained by the determining part 11B in a case where the electronic data are input from the information administration apparatus 110. Further, the external converting apparatus 113 outputs the converted electronic data to the storing part Memr.

The information administration system 100A may be substantialized by, for example, the computer system 1000 of the hardware configuration illustrated in FIG. 2.

### (2. Function)

Referring to FIG. 6, the configuration of the information administration system 100A of the second embodiment is described.

As illustrated in FIG. 6, the information administration system 100A (see FIG. 5) outputs the “operation instruction” in the information administration system 100A obtained by using the inputting part InIF to the controlling pat Cntr in a manner similar to the first embodiment (B501 in FIG. 6).

The controlling part Cntr controls the operation of the information administration system 100A based on the input “operation instruction” (see B502). Specifically, the controlling part Cntr outputs a “change instruction” to the changing part 11A using the information administration program 112 in a case where the “operation instruction” is the “instruction related to the change of the data format”. Further, the controlling part Cntr outputs a “determination instruction” to the determining part 11B using the information administration program 112 in a case where the “operation instruction” is the “instruction related to the change of the data format”. Furthermore, the controlling part Cntr outputs an “identification instruction” to the identifying part 12 using the information administration program 112 in a case where the “operation instruction” is the “instruction related to the conversion of the data format”. Further, the controlling part Cntr outputs a “conversion instruction” to the converting part 13 using the information administration program 112 in a case where the “operation instruction” is the “instruction related to the conversion of the data format”. Further, the controlling part Cntr or the inputting part InIF (B501) may further output the “operation instruction” or the like to the storing part Memr.

The changing part 11A changes the data information (property information or the like) based on the output “change instruction” in a manner similar to the first embodiment (B503).

The determining part 11B determines whether the format information (a data format) of the data information (property information or the like) is changed based on the input “determination instruction” in a manner similar to the first embodiment (see B504). Further, the determining part 11B outputs the “determination data” to the identifying part 12 and the storing part Memr (B504).

The identifying part 12 identifies the data format based on the input “determination data” in a manner similar to the first embodiment (see B505). Further, the identifying part 12 outputs the “identification data” to the converting part 13 and the storing part Memr or the external converting apparatus 113 (see B505).

Specifically, the information administration system 100A (the identifying part 12) determines whether the data format is included in a predetermined format. Said differently, the information administration system 100A (the identifying part 12) determines whether the data format can be converted using a control program (a driver) installed in the information administration apparatus 110 (the converting part 13). The predetermined format corresponds to various file types (and versions) such as a text file, an image (movie) file, a document administration file, a spreadsheet file, a presentation file, or the like.

The information administration system 100A (the identifying part 12 outputs the result of the identification (hereinafter, “identification data”) to the converting part 13 (see B505) in a case where the information administration system 100A (the identifying part 12) determines that the data format of the electronic data can be converted using the converting part 13. Further, the information administration system 100A (the identifying part 12) outputs the “identification data” to the external converting apparatus 113 and the storing part Mem in a case where the information administration system 100A (the identifying part 12) determines that the data format of the electronic data cannot be converted using the converting part 13 (see B505).

The converting part 13 converts the data format of the electronic data based on the input “identification data” in a manner similar to the first embodiment (see B506a). The converting part 13 outputs the conversion data to the storing part Memr (See B506a).

On the other hand, the external converting apparatus 113 converts the data format of the electronic data based on the input “identification data” (see B506b). Specifically, the external converting apparatus 113 converts the electronic data to be the data format that is identified by the identifying part 12 using the built-in control program, as a conversion step. Further, the external converting apparatus 113 outputs the “conversion data” to the storing part Memr (See B506b).

The converting part 13 and the external converting apparatus 113 may further perform an addition of the “information related to the conversion which had been performed” to the data information of the converted electronic data (an information addition step) and a storage of a copy of the electronic data in a predetermined folder (the storing part 14) before converting the electronic data (a copy storage step).

The storing part Memr stores the “determination data” of the determining part 11B, the “identification data” of the identifying part 12, the “conversion data” of the converting part 13, the “conversion data” of the external converting apparatus 113, and so on (see B507).

The outputting part OutIF outputs the system information or the like stored in the storing part Memr in a manner similar to the first embodiment (see B508).

### (3. Processing Flow)

Referring to FIG. 7, an exemplary operation of administering data (monitoring the data format) by the information administration system 100A of the second embodiment is described.

As illustrated in FIG. 7, at first, the information administration system 100A performs steps S601 to step S604 in a manner similar to a case of steps S301 to S304 (see FIG. 4). Thereafter, the information administration system 100A performs step S605.

Subsequently, in step S605, the information administration system 100A determines whether the converting part can convert the data format of the electronic data using the controlling part Cntr. In a case where the information administration system 100A determines that the converting part can convert the data format of the electronic data, the process goes to step S606. In a case where the information administration system 100A determines that the converting part cannot convert the data format of the electronic data, the process goes to step S606a. Specifically, the controlling part Cntr determines whether the data format can be converted by specifying the data format using the input “identification data” and determining whether the specified data format is included in the predetermined format.

In steps S606 to S608, the information administration system 100A converts the data format using the converting part 13, the storing part Memr, and the controlling part Cntr, stores the converted electronic data, and updates the data information of the converted electronic data, in a manner similar to the first embodiment. Thereafter, the information administration system 100A proceeds to END in FIG. 7 where the operation of converting the data format ends.

Meanwhile, in step S606a, the information administration system 100A transfers the result of the identification obtained in step S603 and the result of the determination obtained in step S605 to the external converting apparatus 113. Thereafter, the information administration system 100A performs step S606b.

Next, in step S606b, the external converting apparatus 113 converts the data format based on the result of the identification obtained in step S603 and the result of the determination obtained in step S605. After the conversion, the external converting apparatus 113 (the information administration system 100A) performs step S606c.

Next, in step S606c, the external converting apparatus 113 (the information administration system 100A) outputs the result of the conversion to the storing part Memr. After the output, the information administration system 100A (the external converting apparatus 113) performs step S607.

As described, the information administration system 100A of the second embodiment can gain an effect similar to the data format conversion system 10 of the first embodiment.

### Third Embodiment

An information administration system 100B (100) of a third embodiment of the present invention is described. The configuration or the like of the information administration system 100B includes the configuration or the like of the data format conversion system 10 of the first embodiment. Therefore, a portion different from the information administration system 100B is mainly described.

1. Configuration

2. Function

3. Processing flow

### (1. Configuration)

Referring to FIG. 8, the configuration of the information administration system 100B (100) of the third embodiment is described. Here, the information administration system 100B is provided to administer (convert a data format, for example) the electronic data stored in advance in the predetermined folder.

The information administration system 100B includes an information accumulating apparatus 120 that includes a changing part 11A, a determining part 11B, an identifying part 12, and a converting part 13, and an information processing apparatus 130 controlling execution of predetermined information processing. Meanwhile, the configuration of the information administration system 100B is an example and can be used for various system or configuration examples in response to a usage or a purpose.

The information accumulating apparatus 120 executes predetermined information processing based on an instruction from the information processing apparatus 130. The information accumulating apparatus 120 further includes a reporting part 121 that reports a result of determination obtained by the determining part 11B to the information processing apparatus 130. The reporting part 121 reports the result of the determination to the information processing apparatus using a typical interface.

The information processing apparatus 130 controls execution of the predetermined information processing based on the result of the determination reported from the reporting part 121. Here, the predetermined information processing substantializes functions of each of the identifying part 12 and the converting part 13. The predetermined information processing substantialize functions may be determined in advance by a test, calculation or the like.

The information administration system 100B may be substantialized by, for example, the computer system 1000 of the hardware configuration illustrated in FIG. 2.

### (2. Function)

Referring to FIG. 9, the configuration of the information administration system 100B of the third embodiment is described.

As illustrated in FIG. 9, the information administration system 100B (see FIG. 8) outputs the “operation instruction” in the information administration system 100B obtained by using the inputting part InIF to the controlling part Cntr in a manner similar to the first embodiment (B801 in FIG. 6).

The controlling part Cntr controls the operation of the information administration system 100B based on the input “operation instruction” in a manner similar to the first embodiment (see B802).

The changing part 11A changes the data information (property information or the like) based on the output “change instruction” in a manner similar to the first embodiment (B803).

The determining part 11B determines whether the data information (the format information indicative of a data format) of the data information is changed based on the input “determination instruction” in a manner similar to the first embodiment (see B803B). Further, the determining part 11B outputs the “determination data” to the reporting part 121 and the storing part Memr (B803B).

The reporting part 121 outputs “report data” produced by using the input “determination data” to the information processing apparatus 130 and the storing part Memr (B804).

The information processing apparatus 130 controls the operation of the information accumulating apparatus 120 based on the reported “report data” (B805). Specifically, the information processing apparatus 130 controls the operation of the identifying part 12 or the like by outputting an “information processing instruction” to the identifying part 12 and the converting part 13 of the information accumulating apparatus 120. The information processing apparatus 130 may control the operation of the identifying part 12 or the like by further using a control program stored in advance or the like.

The identifying part 12 identifies the data format based on the input “information processing instruction” (see B806). Specifically, the identifying part 12 identifies the data format based on the format information indicative of the data format obtained by the determination by the determining part 11B as an identification step. Further, the identifying part 12 outputs the “identification data” to the converting part 13 and the storing part Memr (see B806).

The converting part 13 converts the data format based on the input “information processing instruction” (see B807). Specifically, the converting part 13 converts the electronic data so as to have the data format identified by the identifying part 12 as a conversion step. The converting part 13 outputs the “conversion data” to the storing part Memr (See B807). The converting part 13 may further perform an addition of the “information related to the conversion which had been performed (or a character string)” to the data information of the converted electronic data (an information addition step) and a storage of a copy of the electronic data in a predetermined folder before converting the electronic data (a copy storage step).

The storing part Memr stores the “determination data” of the determining part 11B, the “identification data” of the identifying part 12, and the “conversion data” of the converting part 13 in a manner similar to the first embodiment (see B808).

The outputting part OutIF outputs the system information or the like stored in the storing part Memr in a manner similar to the first embodiment (see B809).

### (3. Processing Flow)

Referring to FIG. 10, an exemplary operation of administering data (monitoring the data format) by the information administration system 100B of the third embodiment is described.

As illustrated in FIG. 10, the information administration system 100B performs steps S901 and S902 in a manner similar to a case of steps S302 and S303 (see FIG. 4). Thereafter, the information administration system 100B performs step S903.

Subsequently, in step S903, the information administration system 100B reports the result of the determination obtained by the determining part 11B using the reporting part 121 of the information accumulating apparatus 120 to the information processing apparatus 130 (a report step). Thereafter, the information administration system 100B performs step S904.

In step S904, the information administration system 100B uses the information processing apparatus 130 to select predetermined information processing performed by the information accumulating apparatus 120. Further, the information administration system 100B controls the operation of the information accumulating apparatus 120 using the information processing apparatus 130 based on the selected predetermined information processing. Thereafter, the information administration system 100B performs step S905.

Next, in step S905, the information administration system 100B identifies the data format to be changed using the identifying part 12 based on the data information to be changed (an identification step). Specifically, the identifying part 12 identifies the data format to be changed based on the predetermined information processing (the information processing instruction) input from the information processing apparatus 130. Thereafter, the identifying part 12 outputs the identification data obtained by the identification to the converting part 13. Thereafter, the information administration system 100B performs step S906.

In step S906, the information administration system 100B produces a copy of the electronic data to be converted using the controlling part Cntr in a manner similar to the first embodiment. Thereafter, the information administration system 100B performs step S907.

In step S907, the data format conversion system 100B converts the data format of the electronic data based on the “identification data” obtained by identifying in step S905 using the converting part 13. Specifically, the converting part 13 converts the data format of the electronic data in the predetermined folder based on the predetermined information processing (the information processing instruction) input from the information processing apparatus 130. Thereafter, the converting part 13 outputs the conversion data obtained by converting the data format to the storing part Memr. After the output, the information administration system 100B performs step S908.

In steps S908 to S909, the information administration system 100B stores the electronic data whose data format has been converted using the storing part Memr, the controlling part Cntr, or the like, and updates the data information (property information or the like) of the converted electronic data, in a manner similar to the first embodiment. Thereafter, the information administration system 100B proceeds to END in FIG. 9 where the operation of converting the data format ends.

As described, the information administration system 100B of the third embodiment can gain an effect similar to the data format conversion system 10 of the first embodiment. (Program for a data format conversion method and a recording medium storing the program)

A program Pr of a data format conversion method of the first embodiment of the present invention performs a data format conversion method that converts the format of the electronic data and includes a storage step that stores data information including electronic data and data information indicative of a data format of the electronic data, a change step that changes the data information stored in the storage step, a determination step that determines whether the format information is changed in the change step, an identification step that identifies the data format from the changed format information when it is determined that the format information is changed in the determination step, and a conversion step that converts the data format of the stored electronic data based on the identified data format identified in the identification step. Further, the program Pr may perform the data format conversion method wherein the conversion step further includes an information addition step of adding the “information related to the conversion which had been performed” to the property information of the converted electronic data. Further, the program Pr may perform the data format conversion method further including a copy storage step that stores a copy of the electronic data in a predetermined folder before converting the electronic data. With this configuration, an effect substantially similar to the data format conversion system 10 of the first embodiment is obtainable.

Further, the program Pr may be installed in a recording medium Md readable by a computer that records the above program Pr. The recording medium Md recording the above program Pr may be a floppy disk (FD), a compact disk read only memory (CD-ROM), a CD recordable (CD-R), a digital versatile disk (DVD), a tape drive, and a computer readable medium such as a flash memory, a semiconductor memories such as a RAM, a ROM, or the like, a memory card, or a hard disc drive (HDD).

### EXAMPLES

Examples of the present invention are described using the data format conversion system 10 of the first embodiment, the information administration system 100A of the second embodiment, and the information administration system 100B of the third embodiment.

### Example 1

A file server system 10F including the data conversion system 10 of the first embodiment of the present invention is described as Example 1. The file server system 10F administers file data (electronic data) stored in advance in a predetermined folder inside a server in Example 1. The configuration or the like of the file server system 10F of Example 1 includes the configuration or the like of the data format conversion system 10 of the first embodiment. Therefore, a portion different from the data format conversion system 10 is mainly described in the following order.

1. Configuration and function

2. Processing flow

### (1. Configuration and Function)

As illustrated in FIG. 11, the file server system 10F of Example 1 includes a folder monitoring part 11F being the determining part 11B, an extension determining part 12F being the identifying part 12, and a file converting part 13F being the converting part 13. Further, the file server system 10F includes a controller CntrF as the controlling part Cntr. Further, the file server system 10F includes a folder Fld as a memory area (the predetermined folder) of the storing part Memr and a user interface part GUI as the inputting part InIF and the outputting part OutIF.

The folder monitoring part 11F monitors (determines) whether the file name (the data information) of the file data is changed (see B1003 of FIG. 11). The folder monitoring part 11F of Example 1 determines whether the file name is changed by periodically detecting the file name of the file stored in advance inside the folder Fld based on the input “monitor instruction”. Specifically, the folder monitoring part 11F can determine whether the file name is changed by comparing the file name (the character string) at the previous detection with the file name (the character string) at the current detection. Further, the folder monitoring part 11F outputs a result (hereinafter, referred to as “monitor data”) of the monitor to the extension determining part 12F.

The extension determining part 12F determines (identifies) the file format (the data format) of the file data to be subject to information processing based on the input “monitor data” (see B1004). The extension determining part 12F determines the file format using the file name detected by the folder monitoring part 11F in a case where the folder monitoring part 11F determines that the file name of the file data is changed. The extension determining part 12F may determine the file format based on, for example, the extension (a character string) of the file name. Further, the extension determining part 12F outputs a result (hereinafter, referred to as “determination data”) of the determination to the file converting part 13F.

Here, the extension is a character string for identifying a file type (a format) attached to the end of the file name. Further, the extension determining part 12F (the identifying part 12) may determine the file format at a portion other than the extension of the file name. Said differently, the identifying part 12 (the extension determining part 12F) used in Example 1 of the present invention may determine the file format using an arbitrary part of the character string of the file name.

The file converting part 13F converts the file format of the file data based on the input “determination data” (and the “monitor data”) (see B1005). The file converting part 13F of Example 1 converts the file format stored inside the folder Fld based on the file format determined by the extension determining part 12F. Further, the file converting part 13F stores the “conversion data” obtained by the conversion in the folder Fld. Further, the file converting part 13F may add a “character string (information) related to the completed conversion” to the file name of the converted file data. With this, the file server system 10F can efficiently search (detect) the converted file stored in the folder Fld using the added “character string related to the completed conversion” as a keyword in response to the operation instruction from the outside.

Further, the file converting part 13F may store a copy of the file before converting the file data. With this, the file server system 10F can select re-conversion or non-conversion using an original file (the file data before the conversion) in a case where the conversion is canceled by an unpredictable reason during the file data are being converted. Further, in a case where a defect is included in the converted file, the original file (the file data before the conversion) is used to convert again.

The user interface part GUI inputs or outputs information to or from the file server system 10F by a user operation (see B1001). The user interface part GUI inputs and outputs operation information, a result of monitor, or the like using a wired communication and/or a wireless communication. Specifically, the user interface part GUI of Example 1 outputs the input “operation instruction” to the controller CntrF. Further, the user interface part GUI outputs (for example, displays) the information inside the folder Fld. The user interface part GUI uses, for example, an operation button, an operation panel, a touch panel, a keyboard, a mouse, or the like.

The controller CntrF controls operations of the configuration by instructing the operations to the configuration of the file server system 10F based on the input “operation instruction” (see B1002). The controller CntrF controls the operation of the file server system 10F to control the operation of converting the file format of the file data stored in advance inside the folder Fld. Specifically, the controller CntrF outputs a “monitor instruction” to the folder monitoring part 11F in a case where the “operation instruction” is the “instruction related to the conversion of the file format”. Further, the controller CntrF outputs a “determination instruction” and a “conversion instruction” to the extension determining part 12F and the file converting part 13F in a case where the operation instruction is the “instruction related to the conversion of the file format”. The file server system 10F may be substantialized by, for example, the computer system 1000 of the hardware configuration illustrated in FIG. 2.

### (2. Processing Flow)

Referring to FIGS. 12 and 13, an exemplary operation by the file server system 10F of controlling (monitoring, converting) the file data (the file format of the file data) is described in Example 1.

As illustrated in FIG. 12, at first, the file server system 10F starts a monitor operation in step S1101. After starting the monitor operation, the file server system 10F performs step S1102.

Next, in step S1102, the file server system 10F acquires the file name (the information related to the extension) of the file data using the folder monitoring part 11F (a detection step). Thereafter, the file server system 10F performs step S1103.

Subsequently, in step S1103, the file server system 10F determines whether the extension of the file name is changed using the folder monitoring part 11F and the extension determining part 12F. In a case where the extension of the file name is changed, the file server system 10F performs step S1104. In the other cases, the file server system 10F performs step S1109. Here, the folder monitoring part 11F and the extension determining part 12F compare the extension (the character string) of the file name at the previous detection with the extension (the character string) of the file name at the current detection to determine whether the extension of the file name is changed.

In step S1104, the file server system 10F produces a copy of the file using the file converting part 13F before converting the file. Further, the file server system 10F stores the produced copy in the folder Fld (a copy storage step). Thereafter, the file server system 10F performs step S1105.

In step S1105, the file server system 10F converts the extension of the produced copy of the file to the extension given before the change using the file converting part 13F. Thereafter, the file server system 10F performs step S1106.

In step S1106, the file server system 10F determines whether the file can be converted to the file format determined in step S1103 using the controller CntrF or the like. In a case where the file server system 10F determines that the file is convertible to the file format, the file server system 10F performs step S1107. In the other cases, the file server system 10F performs step S1110.

Here, the file server system 10F may determine whether the file is convertible using, for example, a table illustrated in FIG. 13 (a format conversion table). The file server system 10F determines that the file is convertible in a case where the file format (the extension) determined in step S1103 exists in a list of the extensions stored in a format conversion table, for example. Further, the file server system 10F may store in advance a list of the extensions whose file formats are inconvertible, and may determine that the file is inconvertible using the list, for example. The files (the extensions) whose file formats are convertible include document data (*.doc, *.xls, *.ppt, *.pdf, or *.html), image data (*.jpeg, *.ttf, or *.bmp), movie data (*.avi, *.mpg, *.mov), audio data (*.mp3, *.wav, or *.wma), or execution file (*.exe or *.dll), or the like that are produced by various application software, in addition to the file formats illustrated in FIG. 13.

In step S1107, the file server system 10F converts the file format of the file data using the file converting part 13F based on the information related to the extension acquired in step S1102. Thereafter, the file converting part 13F stored the file whose file format is converted in the folder Fld. Thereafter, the file server system 10F performs step S1108.

In step S1108, the file server system 10F uses the file converting part 13F to add the “character string related to the completed conversion (for example, “converted”)” to the file name of the converted file stored in the folder Fld. Thereafter, the process returns and the file server system 10F performs step S1102.

Meanwhile, in step S1109, the file server system 10F uses the controller CntrF to determine whether the monitor operation ends using information or the like input by the user interface part GUI. In a case where the monitor operation ends, the file server system 10F ends its operation of administering the file data at END. In the other cases, the process returns and the file server system 10F performs step S1102.

Further, in step S1110, the file server system 10F uses the file converting part 13F to add a “character string related to impossible conversion (e.g., an “inconvertible file”)” to the file name of the file stored in the folder Fld. Thereafter, the file server system 10F performs step S1109.

As described, the file server system 10F of Example 1 can gain an effect similar to the data format conversion system 10 of the first embodiment. (Program for a data format conversion method and a recording medium storing the program)

The program Pr for the data format conversion method (the file server system 10F) of Example 1 of the present invention is performed in a data format conversion system that converts a format of electronic data and includes a storing part that stores the electronic data and format information indicative of data format of the electronic data, a changing part that changes the data information stored in the storing part, a determining part that determines whether the format information included in the data information is changed by the changing part, an identifying part that identifies the data format when the determining part determines that the format information is changed, and a converting part that converts the data format of the electronic data stored in the storing part based on the data format identified by the identifying part, wherein a data format conversion method is performed so that a conversion step includes an information addition step of adding information related to a conversion which had been performed to property information of the converted electronic data, the electronic data are file data, the data format is a file format, and the conversion step converts the file format of the file data based on the file format identified by an identification step. Further, the program Pr of Example 1 may perform the data format conversion method, wherein the property information includes information related to an extension corresponding to the file format, and the identification step identifies the file format based on the information related to the extension. Further, the program Pr of Example 1 may perform the data format conversion method, wherein the property information further includes information related to a file name of the file data, the conversion step adds the information related to the conversion which had been performed to the information related to a file name of the file data. With this configuration, an effect substantially similar to the data format conversion system 10 of the first embodiment is obtainable.

Further, within Example 1, the program Pr may be installed in a recording medium Md readable by a computer that records the above program Pr.

### Example 2

Example 2 of the present invention is described using the information system 200 including the file server system 10F of Example 1. The information system 200 converts (edits) a format (a data format) of data (electronic data) stored in advance in an apparatus (e.g., a server) using another apparatus (e.g., an information terminal). The configuration or the like of the information system 200 has a portion similar to the configuration or the like of the file server system 10F of Example 1. Therefore, different portions are mainly described in the following order.

1. Hardware configuration

2. Function

3. Processing flow

### (1. Hardware Configuration)

Referring to FIG. 14, the information system 200 of Example 2 includes an information terminal 210 that can browse data (electronic data) stored inside a predetermined folder of the file server system 10F, and a communication device 220 that causes the file server system 10F to communicate with the information terminal 210. Further, the information system 200 of Example 2 may further include an external apparatus 220E that converts a data format.

Referring to FIG. 15, the information system 200 of Example 1 includes a tablet terminal (or a smart phone or other smart devices) 210SP and a personal computer 210PC as the information terminal 210. Further, the information system 200 includes a network NW including a wired communication and/or a wireless communication as the communication device 220. Further, the information system 200 includes a server 100SV1 as the file server system 10F (the data format conversion system 10). Further, the information system 200 can use an external conversion server (SV) 100SV2 and a multifunction peripheral (MFP).

Here, the smart device is a highly-functional portable terminal having performance similar to a personal computer. The smart device can send and receive an image or the like through a network and can capture image data by a camera. Further, the smart device includes a touch panel to receive an input operation intuitively given by a user.

The network NW is a closed network such as an intranet that exists within a company or a network connecting the closed network with an external network such as the Internet.

Further, the servers 100SV1 and 100SV2 may be one mode of computer. The servers 100SV1 and 100SV2 include a CPU, a RAM, a ROM, a network card, an input device, a HDD, or the like, which are mutually connected by an internal bus.

The information terminal 210 includes an editing portion 211 that edits property information (data information such as a file name) related to one data (e.g., file data) being browsed, and an outputting portion 212 that outputs a result of the edit obtained by the editing portion 211. The information terminal 210 causes the output result of the edit to be input in the folder monitoring part 11F (the determining part 11B) through the communication device 220. The folder monitoring part 11F determines whether the property information (the format information of the data information such as the file name) is changed based on the input result of the edit in Example 2.

The information terminal 210 may be a transportable information processing apparatus such as a portable phone, a personal digital assistant (PDA), a note PC, or a laptop PC. Further, iOS, Android (“Android” is a registered trademark), Windows (the “Windows” is a registered trademark), or another universal OS may be installed in the information terminal 210. Further, the information terminal 210 may communicate with the file server system 10F through an access point and/or a base station by a communication device that complies with a standard such as a wireless LAN, long term evolution (LTE), HSDPA, CDMA, GSM, or the like.

The communication device 220 outputs data stored in a predetermined folder that is included in the communication device 220 to the information terminal 210. The communication device 220 may use, for example, TCP/IP. Further, the communication device 220 may use, for example, FTP, SMB, HTTP, HTTPS, Web-based Distributed Authoring and Versioning (Web DAV), or the like.

The external apparatus 220E may be installed in the intranet (the closed network). Further, the external apparatus 220E may be a service of a so-called cloud computing system. Here, the external conversion SV (and an external DB) of the external apparatus 220E stores a driver (information necessary for converting a program, a mathematical formula, and another data format) that is used for converting the file format. The MFP of the external apparatus 220E is an image forming apparatus not only functioning as a copier but also having a facsimile function, a printer function, a scanner function, or the like. The MFP (the image forming apparatus) provides predetermined processing (a conversion of a data format) to the input image data.

### [Hardware Configuration]

<Tablet Terminal 210SP>

FIG. 16 illustrates an exemplary hardware configuration of the tablet terminal 210SP (an exemplary information terminal 210SP).

The tablet terminal 210SP (a portable terminal) includes a CPU 2121 that controls an entire operation of the portable terminal, a ROM 2122 that stores a basic input and output program, a RAM 2123 that is used as a work area for the CPU 2121, an EEPROM 2124 that reads or writes data in conformity with a control of the CPU 2121, a Complementary Metal Oxide Semiconductor (CMOS) 2125 that capture an image of a photographic subject and acquires an image data of the photographic subject in conformity of the control of the CPU 2121, an electromagnetic compass or a gyrocompass that detects earth magnetism, various acceleration and direction sensor 2126 such as an acceleration sensor, and a media drive 2128 that controls reading or writing (storing) data from or to a recordable media 2127 such as a flash memory. The recordable media 2127 is configured such that data already recorded in the recordable media 2127 are read out and new data are written in the recordable media 2127 in conformity with the control of the media drive 218, and the recordable media 2127 is freely attachable or detachable.

The EEPROM 2124 stores an operating system (OS) executed by the CPU 2121, association information necessary for a network setup, or the like. An application (hereinafter, referred to as a “collaboration processing application”) used to perform a collaboration processing service is stored in the EEPROM 2124 or the recordable media 2127. Further, the CMOS sensor 2125 is a charged coupled device that digitizing the image of the photographic subject. As long as the image of the photographic subject is captured, a Charge Coupled Device (CCD) sensor may be used instead of the CMOS sensor.

Further, the tablet terminal 210SP includes an audio input portion 2129 that converts sound to an audio signal, an audio output portion 2130 that converts the audio signal to the sound, an antenna 2131, a communication portion 2132 that performs communication with the nearest base station by a wireless communication signal using the antenna 2131, a wireless LAN communication portion 2133 that performs a wireless LAN communication with an access point in conformity with the IEEE80411 standard, a near field wireless communication antenna 2134, a near field communication portion 2135 performing a near field wireless communication (Bluetooth (“Bluetooth” is a registered trademark) communication) using the near field wireless communication antenna 2134, a near field communication portion 2135 that performs the near field wireless communication (Bluetooth (“Bluetooth” is a registered trademark) communication) using the near field wireless communication antenna 2134, a display 2136 such as a liquid crystal, organic EL, or the like that displays the image of the photographic subject, various icons, or the like, a touch panel 2137 that detects a touched position touched by a finger, a touch pen, or the like on the display 2136, and a bus line 2139 such as an address bus or a data bus that electrically connects the above various parts. Further, the tablet terminal 210SP has a dedicated battery 2138, with which the tablet terminal is driven. Further, the audio input portion 2139 includes a mike where the sound is input. The audio output portion 2130 includes a speaker outputting the sound. As such, the tablet terminal 210SP of Example 2 performs various processes described below with the above described hardware configuration.

### <External Apparatus (MFP) 220E>

FIG. 17 illustrates an exemplary hardware configuration of an external apparatus (MFP) 220E of Example 2 of the present invention. The external apparatus 220E is an image forming apparatus (MFP). Hereinafter, an exemplary image forming apparatus (MFP) is described.

The external apparatus 220E includes an operation panel 2221, a storage media I/F 2222, a controller 2223, data communication I/F 2204, a hard disk drive (HDD) 2209, a scanner 2225, and a plotter 2226, which are mutually connected by a bus.

The operation panel 2221 includes an input device 2201 and a display device 2202. The input device 2201 is configured by a hardware key or the like and used to input various operation signals to the external apparatus 220E. The display device 220 is configured to include a display and so on to display various information related to, for example, image forming operations. The data communication I/F 2224 includes an interface device 2208 that connects the external apparatus 220E with data transfer path such as a network. The HDD 2209 stores various data such as received document data and read image data handled in the external apparatus 220E. The HDD 2209 administrates the various data using a predetermined file system or a predetermined database (DB).

The various data stored in the above HDD 2209 include electronic data recorded by an external apparatus such as a smartphone or a digital camera. In this case, the electronic data may be provided to the external apparatus 220E using the recording medium 2204 such as an SD card or uploaded through the data transfer path such as the network. The recording medium 2204 is installed in a drive device 2203 included in the storage media I/F 2222, and various data are stored in the HDD 2209 from the recording medium 2204 through the drive device 2203.

The controller 2223 includes a ROM 2205, a RAM 2206, and a CPU 2207. The ROM 2205 stores the program and various data executed at a time of booting up the external apparatus 220E. Further, the RAM 2206 temporarily stores the various programs and data read out of the ROM 2205 and the HDD 2209. Further, the CPU 2207 executes the program temporarily stored by the RAM 2206. When the controller 2223 receives print data through the data communication I/F 2224, the controller 2223 executes, by the CPU 2207, a program (e.g. a PDL parser) that can interpret a page description language (PDL) read on the RAM 2206 from the ROM 2205, and produces a bit map image by interpreting the print data.

The scanner 2225 includes an image reading apparatus 2210 to optically read an original positioned on a read face of the scanner and produce read image data. The plotter 2226 includes a printer 2221 to print a bit map image on a recording paper by, for example, an electrophotographic process.

As described, the external apparatus 220E (hereinafter, simply referred to as a MFP) substantializes a plurality of functions of a copier, a printer, a facsimile, a scanner or the like using the above hardware configuration.

The hardware configuration including the servers 100SV1, 100SV2, and the personal computer 210PC (the example of the information terminal 210) is substantially similar to the computer system 1000 illustrated in FIG. 2.

### (2. Function)

Referring to FIG. 18, an exemplary function of the information system 200 of Example 2 is described.

Referring to FIG. 18, the information system 200 (FIG. 14) of Example 2 outputs the “operation instruction” (see B1501) that is input using the information terminal 210 (e.g., the editing portion 211) to a Web control part CntrW (the controlling part Cntr) through a WebAPI or the like (see B1502). The information system 200 illustrated in FIG. 14 receives a display request for a list of files or folders from, for example, a tablet terminal or a smartphone using the WebAPI or the like or receives a request for a file operation or the like using the WebAPI or the like.

The Web controlling part 10W controls the operation of the information system 200 based on the input “operation instruction” (see B1503). Specifically, the Web control part 10W outputs a “monitor instruction (a detection instruction)” to the folder monitoring part 11F in a case where the “operation instruction” is the “instruction related to the conversion of the file format”. Further, the Web control part 10W outputs a “determination instruction (not illustrated)” and a “conversion instruction” to the extension determining part 12F and the file converting part 13F in a case where the operation instruction is the “instruction related to the conversion of the file format”.

The folder monitoring part 11F determines whether the file name is changed based on the input “monitor (detection) instruction” (see B1504). Further, the folder monitoring part 11F outputs the “monitor (detection) data” to the extension determining part 12F (see B1504).

The extension determining part 12F determines the file format based on the input “monitor (determination) data” (see B1505). The extension determining part 12F outputs the “determination data” to the file converting part 13F (see B1505). The extension determining part 12F may outputs the “determination data” to the external apparatus 220E (the external DB, the external conversion, or the MFP). With this, in a case where the information system 200 cannot convert the file format using the file converting part 13F, the file format can be converted using the external apparatus 220E (see B1510 to B1513). Here, the external apparatus 220E may convert the file to a single file format or a plurality of file formats.

The file converting part 13F converts the data format based on the input “determination data” (and the “monitor (determination) data”) (see B1506). Further, the file converting part 13F output the “conversion data” to the folder Fld (B1506). The file converting part 13F may perform an addition of the “character string related to the completed conversion” to the file name of the converted file data” (the information addition step) and a storage of a copy of the file before converting the file data inside the folder Fld (a copy storage step).

The folder Fld can output the stored information to the information terminal 210 and the PC (see B1507). The folder Fld can upload the file converted by the file converting part 13F to the information terminal 210 (see B1501) through the WebAPI (not illustrated). The folder Fld can output the file converted by the file converting part 13F to the PC 1509 (see B1509) through the SBM connection portion (see B1508).

### (3. Processing Flow)

Referring to FIG. 19, an exemplary operation by the information system 200 of editing (administering, monitoring, converting, and updating) the file format of the file data is described.

As illustrated in FIG. 19, at first, the information system 200 starts an edit operation in step S1601. Specifically, the information system 200 outputs an operation instruction (hereinafter, “processing request”) that is input using the information terminal 210 (or the PC) and related to the start of the edit to the file server system 10F. Thereafter, the information system 200 performs step S602.

Next, in step S1602, the information system 200 outputs the “processing request” that is input through the WebAPI or the like to the Web control part CntrW (the controlling part Cntr). Thereafter, the information system 200 performs step S1603.

Next, in step S1603, the information system 200 outputs the “folder information (e.g., the stored file information)” of the folder Fld using the Web control part CntrW or the like to the information terminal 210 (of the PC). Thereafter, the information system 200 performs step S1604. The Web control part CntrW or the like can output list information of the folders or the files inside the folder Fld.

Thereafter, in step S1604, in the information system 200, the file name of an arbitrary file in the “folder information” of the folder Fld input in step S1603 is changed using the editing portion 211 of the information terminal 210 (or the input portion of the PC). Thereafter, the information system 200 inputs “information related to the changed file name” into the Web control part CntrW through the WebAPI or the like. Then, the information system 200 performs step S1605. In the information system 200, the file is selected out of the folders or the files that are displayed on a display screed of the PC, the tablet terminal, or the smartphone by, for example, a user, and the extension of the file name of the selected file is changed.

In step S1605, the information system 200 determines whether the extension of the file name corresponding to the “information related to the changed file name” is changed using the folder monitoring part 11F and the extension determining part 12F. In a case where it is determined that the extension of the file name is changed, the information system 200 performs step S1606. In the other cases, the information system 200 ends the operation of editing the file data at END in FIG. 19.

Next, in step S1606, the information system 200 determines whether the file converting part can convert the file format of the file data using the Web control part CntrW or the like. In a case where the information system 200 determines that the file is convertible, the information system 200 performs step S1607. In the other cases, the information system 200 performs step S1610.

In step S1607, the information system 200 converts the file format using the file converting part 13F. Thereafter, the information system 200 performs step S1607.

In step S1608, the information system 200 stores (for example, by an overwrite save) the converted file data using the folder Fld. Thereafter, the information system 200 performs step S1609.

In step S1609, the information system 200 resends (uploads or updates) the converted file data using the Web control part CntrW or the like. Thereafter, the information system 200 ends the operation of editing the file data at END in FIG. 19.

Meanwhile, in step S1610, the information system 200 selects the file conversion method using the extension determining part 12F. Specifically, in Example 2, the extension determining part 12F selects the external conversion SV of the external apparatus 220E or another apparatus as the file conversion method. In a case where the external conversion SV is selected, the information system 200 performs step S1611. In a case where the other apparatus is selected, the information system 200 performs step S1613.

Next, in step S1610, the external conversion SV converts the file data to the file format corresponding to the changed extension using the determination data or the like obtained in step S1605. The external conversion SV may convert the file format by further using a driver or the like stored in the external DB. Thereafter, the external conversion SV outputs the converted file data to the folder Fld. Then, the information system 200 performs step S1608.

Further, in step S1613, it is determined whether the MFP can convert the file format of the file data. In a case where it is determined that the file format is convertible, the information system 200 performs step S1614. In the other cases, the information system 200 performs step S1616.

Next, in step S1614, the file data or the like are input in the MFP. Thereafter, the information system 200 performs step S1615.

In step S1615, the MFP converts the file data to the file format corresponding to the changed extension using the determination data or the like obtained in step S1605. The MFP may convert the file format by further using the driver or the like stored in the external DB. Thereafter, the MFP outputs the converted file data to the folder Fld. Then, the information system 200 performs step S1608.

Further, in step S1616, the information system 200 produces a copy of the file whose file name is changed using the folder monitoring part 11F, the file converting part 13F, or the like, and modifies the extension of the file name of the produced file to the extension given before the change. Thereafter, the information system 200 stores the produced file in the folder Fld. Then, the information apparatus 200 performs step S1609.

As described, within the information system 200 of Example 2, effects similar to those of the file server system 100F of Example 1 are obtainable. (Program for a control method of information system and a recording medium storing the program)

According to a program Pr performing a control method of information system including a control method of information system that converts a format of electronic data, the data format conversion method includes a storage step that stores the electronic data and data information including format information indicative of a data format of the electronic data, a change step that changes the data information stored in the storage step, a determination step that determines whether the format information is changed in the change step, an identification step that identifies the data format using the format information when it is determined in the determination step that the format information is changed, and a conversion step that converts the data format of the stored electronic data based on the data format identified in the identification step.

The control method of information system further includes a browse step that browses the electronic data stored in a predetermined folder, and an editing step that edits property information related to the electronic data that are browsed, wherein the determination step determines whether the property information related to the electronic data is changed by comparing the property information after editing in the editing step with the property information before editing in the editing step, and the conversion step, in a case where the property information is changed in the determination step, stores the converted electronic data in the predetermined folder and outputs to the information terminal.
By this configuration, effects similar to those of the file server system 10F of Example 1 are obtainable.

Further, within Example 1, the program Pr may be installed in a recording medium Md readable by a computer that records the above program Pr.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the data format conversion system has been described in detail, it should be understood that various changes, substitutions, and alterations could be made thereto without departing from the spirit and scope of the invention.

This application is based upon and claims the benefit of priority of the prior Japanese Patent Application No. 2013-53965, filed on Mar. 15, 2013, and the Japanese Patent Application No. 2014-040237 filed on Mar. 3, 2014, the entire contents of which are incorporated herein by reference.

What is claimed is:

1. A data format conversion system of converting a format of electronic data, the data format conversion system comprising:
a storing part that stores the electronic data and data information including format information indicative of a data format of the electronic data;
a changing part that changes the data information stored in the storing part;
a determining part that determines whether the format information included in the data information is changed by the changing part,
an identifying part that identifies the data format using the format information when it is determined by the determining part that the format information is changed, and
a converting part that converts the data format of the electronic data stored in the storing part based on the data format identified by the identifying part.

2. The data format conversion system according to claim 1,
wherein the converting part adds information related to a performed conversion to property information of the electronic data, the data format of which is converted.

3. The data format conversion system according to claim 2,
wherein the electronic data are file data, and
the data format is a file format,
wherein the converting part converts the file format of the file data based on the file format identified by the identifying part.

4. The data format conversion system according to claim 3,
wherein the property information includes information related to an extension corresponding to the file format, and
the identifying part identifies the file format based on the information related to the extension.

5. The data format conversion system according to claim 4,
wherein the property information includes information related to a file name of the file data, and
the converting part adds the information related to the performed conversion to the information related to the file name of the file data.

6. The data format conversion system according to claim 1,
wherein the converting part stores a copy of the electronic data in a predetermined folder before converting the data format of the electronic data.

7. An information administration system comprising the data format conversion system according to claim 1,
wherein the format information is an extension of the electronic data, and
the data information is a name of the electronic data and includes the extension,
the information administration system further comprising:
an outputting part that displays and outputs the name of the electronic data; and
an inputting part that receives an input of an change instruction instructing to change the extension included in the name of the electronic data displayed and output by the outputting part,
wherein the changing part changes the extension in response to the change instruction received by the inputting part,
wherein the determining part determines whether the extension is changed by the changing part,
wherein the identifying part identifies the data format using the extension that is changed when it is determined by the determining part that the extension is changed,
wherein a converting part converts the data format of the electronic data based on the data format identified by the identifying part.

8. The information administration system according to claim 7, the information administration system further comprising:
an information administration apparatus including the converting part; and
an information administration program that outputs a result of identification obtained by the identifying part to the information administration apparatus.

9. The information administration system according to claim 8, the information administration system further comprising:
an external converting apparatus that converts the data format of the electronic data,
wherein the information administration apparatus converts, in a case where it is determined that the data format of the electronic data can be converted by the converting part, the data format of the electronic data using the converting part, and outputs, in a case where it is determined that the data format of the electronic data cannot be converted by the converting part, the electronic data to the external converting apparatus,
wherein, in a case where the electronic data are input from the information administration apparatus, the external converting apparatus converts the data format of the electronic data based on the result of the identification and outputs the electronic data, the data format of which is converted, to the information administration apparatus.

10. An information administration system comprising the data format conversion system according to claim 1, the information administration system further comprising:
an information accumulating apparatus including the changing part, the determining part, the identifying part, and the converting part; and
an information processing apparatus that controls an execution of predetermined information processing in the information accumulating apparatus,
wherein information accumulating apparatus further includes a reporting part that reports a result of determination obtained by the determining part to the information processing apparatus, and executes the predetermined information processing based on an instruction from the information processing apparatus,
wherein the information processing apparatus controls the execution of the predetermined information processing in the information accumulating apparatus based on the reported result of the determination.

11. An information system comprising the data format conversion system according to claim 1, the information system further comprising:
an information terminal that can browses data stored inside a predetermined folder; and
a communication device that outputs the data stored in the predetermined folder to the information terminal,
wherein the information terminal includes
an editing portion that edits property information related to data being browsed, and
an outputting portion that outputs a result of edit obtained by the editing portion,
wherein the information terminal causes the output result of the edit to be input in the determining part through the communication device,
wherein the determining part determines whether the format information included in the data information is changed based on the result of the edit.

12. A data format conversion method that converts a format of electronic data, the data format conversion method comprising:
a storage step that stores the electronic data and data information including format information indicative of a data format of the electronic data,
a change step that changes the data information stored in the storage step,
a determination step that determines whether the format information is changed in the change step,
an identification step that identifies, when it is determined in the determination step that the format information is changed, the data format using the changed format information, and
a conversion step that converts the data format of the stored electronic data based on the data format identified in the identification step.

13. A data format conversion method according to claim 12,
wherein the conversion step further includes an information addition step that adds information related to a performed conversion to property information of the electronic data, the data format of which is converted.

14. The data format conversion method according to claim 13,
wherein the electronic data are file data, and
the data format is a file format,
wherein, in the converting step, the file format of the file data is converted based on the file format identified in the identification step.

15. The data format conversion method according to claim 14,
wherein the property information includes information related to an extension corresponding to the file format, and
in the identifying step, the file format is identified based on the information related to the extension.

16. The data format conversion method according to claim 15,
wherein the property information includes information related to a file name of the file data, and
in the converting step, the information related to the performed conversion is added to the information related to the file name of the file data.

17. The data format conversion method according to claim 12,
wherein, in the converting part, a copy of the electronic data is stored in a predetermined folder before converting the data format of the electronic data.

18. A control method of an information system comprising the data format conversion method according to claim 12, the control method of the information system further comprising:
a browse step that browses the electronic data stored in a predetermined folder using an information terminal;
an editing step that edits property information related to the electronic data that are browsed using the information terminal,
wherein, in the determination step, it is determined whether the property information related to the electronic data is changed by comparing the property information after editing in the editing step with the property information before editing in the editing step, and
wherein, in the conversion step, in a case where the property information is changed in the determination step, the converted electronic data are stored in the predetermined folder and are output to the information terminal.

19. A non-transitory computer-readable storage medium storing a program for causing a computer to execute a data format conversion method that converts a format of electronic data, the data format conversion method comprising:
a storage step that stores the electronic data and data information including format information indicative of a data format of the electronic data,
a change step that changes the data information stored in the storage step,
a determination step that determines whether the format information is changed in the change step,
an identification step that identifies, when it is determined in the determination step that the format information is changed, the data format using the changed format information, and
a conversion step that converts the data format of the stored electronic data based on the data format identified in the identification step.
